(19) United States
(12) Patent Application Publication
(10) Pub. No.: US 2013/0042318 A1
(43) Pub. Date: Feb. 14, 2013

(54) Authentication System and Method Using Arrays

(71) Applicants: Rakesh Thatha, Ongole (IN); Pavan Thatha, Ongole (IN)

(72) Inventors: Rakesh Thatha, Ongole (IN); Pavan Thatha, Ongole (IN)

(21) Appl. No.: 13/639,117

(22) PCT Filed: Apr. 28, 2011
(86) PCT No.: PCT/IN2011/000290

§ 371 Date: Oct. 3, 2012

(30) Foreign Application Priority Data
Apr. 29, 2010 (IN) 1190CHE2010

(51) Int. Cl. G06F 21/00

(52) U.S. Cl. 726/18

(57) ABSTRACT

The present invention relates to a user authentication system and in particular to a method and system in which the user has to apply a transformation which can be an ArrayCard consists of transparent and/or opaque cells of Physical (static/electronic) or Virtual form or it can be a form of secret remembered which needs to be applied on an array of cells to arrive at a unique One-Time-SecretCode for each authentication request along with a sequence of cells/positions (pattern) in an array as a secret pattern. First, user undergoes registration phase to get authenticated to access the application. While registering user applies a transformation on the array of cells displayed on user terminal and registers a pattern by selecting the corresponding symbols from the resultant array. Once user gets registered, then he can access the application by authenticating himself to the system. At the authentication phase, user has to apply the transformation on the array of cells displayed and enter the symbols from the resultant array as One-Time-SecretCode by recollecting his own secret pattern. This user entered One-Time-SecretCode will be checked by the system and if found genuine, access will be granted or else access will be denied.

### FIELD OF INVENTION

The present invention relates to a user authentication system and in particular a method and system for a secure transaction which is employed based on the transformation of displayed array of cells and a secret pattern, which can be applied to the result of the transformation to derive a One-Time-SecretCode. The transformation can take any form, typically an ArrayCard.

### BACKGROUND OF THE INVENTION

User Authentication Systems are widely used in various fields for validating the identity of the user. The User Authentication system attempts to prevent unauthorized use by requiring users to validate their identity for accessing the resource. In the Password-Based Authentication system, each user is allowed to select a set of characters as Password, which will be his/her key. If we observe the system closely, every time the user is presenting the same key to the system. If the intruder uses either Keyloggers or spyware programs to get what the user is entering, then the intruder will also know what the user knows. Once the intruder gets the key, then there is no way that the authentication server can distinguish between the genuine user and the intruder. This is because the system does not authenticate the identity of a user, only who the key holder claims to be. Since the authentication system can only verify the user's true identity, methods must be in place to reduce the opportunity for an unauthorized user to appear as an authorized user and access the system. This can be accomplished by, ‘the user instead of telling the secret, proves he knows the secret’.

There are various systems proposed which are based on the above principle which will increase the security of the authentication system. Among those the patents U.S. Pat. No. 6,246,769, GB2433147, US2005/0160297, and US2007/0226784 propose, the user to remember a sequence of positions or cells in an array. And every time when the user would like to authenticate he needs to enter the values present in user's selected positions in the array displayed by the system. But the above systems are prone to attacks, like Keyloggers and Screenloggers (captures the keystrokes and takes the screenshot of the array displayed on the User-Terminal), then hacker will be able to identify the user's secret pattern there by compromising the user's secret. The other vulnerability for such systems is phishing. By using Phishing technique, hacker can easily compromise the user's secret pattern.

There are other classes of systems. The patents US2006/0018467, US2006/0018467 are based on providing a unique card to the user. The major problem with these methods is that if the card is stolen by the hacker/wrong person it would be easy for them to break into the system.

### SUMMARY OF THE INVENTION

The objective of the present invention is to provide a method and system for authenticating a user based on the transformation of displayed array of cells and a pattern, which can be applied to the result of the transformation and derives a One-Time-SecretCode.

The invention method can be used for the authentication of the user to the application or the authentication of any application with any other application. The transformation can be applied to the array of cells to derive a One-Time-SecretCode using the remembered pattern. The transformation can take any form, typically an ArrayCard.

The ArrayCard mentioned will take any of the following formats:

There are various broad ways in which the transformation can be applied to derive the One-Time-SecretCode.
(i) Use of Physical ArrayCards
(ii) Use of Virtual ArrayCards
(iii) An Electronic ArrayCard where the displayed matrix would be changing dynamically

More details about the above listed transformations are elaborated in following sections.

### BRIEF DESCRIPTION OF THE DRAWINGS

FIG. 1 illustrates Registration Phase—with user's Physical ArrayCard

FIG. 2 illustrates Authentication Phase—Array generated based on User-Id

FIG. 3 and FIG. 4 illustrate Authentication Phase—using two sided Physical ArrayCard and system specified overlap position of Physical ArrayCard respectively

FIG. 5 shows pattern chosen by user during Registration for 3×3 array

FIG. 6 shows resultant array formation for single sided Physical ArrayCard

FIG. 7 depicts resultant array formation for two-sided Physical ArrayCard

FIG. 8 depicts resultant array formation when overlap positions of Physical ArrayCard are specified

FIG. 9 illustrates Registration Phase, Pattern Registration for Virtual ArrayCard

FIG. 10 illustrates Registration Phase, Virtual ArrayCard Initialization/Generation

FIG. 11 illustrates Authentication Phase using Virtual ArrayCard

FIG. 12 shows authentication phase when overlap positions of Virtual ArrayCard are specified

FIG. 13 illustrates Virtual ArrayCard transformation at one instant
a) array from system
b) Virtual ArrayCard with application
c) resultant array

FIG. 14 illustrates the Virtual ArrayCard transformation at another instant
a) array from system
b) Virtual ArrayCard with application
c) resultant array

FIG. 15 shows resultant array formation when overlap positions of Virtual ArrayCard are specified

FIG. 16 shows array displayed on User-Terminal with numbers

FIG. 17 illustrates array displayed on User-Terminal with pictures in each cell

FIG. 18 shows array displayed on User-Terminal with each cell divided into two sub-cells

### DETAILED DESCRIPTION OF THE INVENTION

This section contains detailed description of the invention along with the list of transformations that can be applied.

### 1) Use of Physical ArrayCard

In this embodiment, every user has a particular application on his respective device which could be a Desktop or Mobile or a Web Application, or any other display device. Each user is given a Physical ArrayCard which can be of any size, shape and material. The users would be given distinct or indistinct ArrayCard(s) and using these ArrayCard(s) they would be able to login to their respective application(s) through their display terminals. The application in which the Array of Cells is displayed can be same or different from the application/system for which the access needs to be provided. When both the applications/systems are different, they can be in same or different devices.

A further explanation on this particular embodiment follows.

### 1. Registration: Issuing of Physical ArrayCard

Each user is issued a unique ArrayCard. ArrayCard consists of an array of cells with some cells being transparent and other being opaque. The transparent or opaque cells can further differ by any means like using colors, any other indications. The ArrayCard can be of any size or shape. Some typical shapes can be square, rectangular etc. The opaque cells will have a character imprinted on it. In a particular embodiment, some of the opaque cells may be left blank. In one of the particular embodiments there can be multiple characters imprinted on each opaque cell. Sample ArrayCard is shown in FIG. 6(ii).

When one puts the ArrayCard on top of anything, they will be able to partially see what's in the background through transparent cells. The number of opaque cells and transparent cells can be decided based on the application/user need and the security required for the application. The positions where the transparent and opaque cells need to be placed are determined randomly or based on any specific requirement of the application/user. The characters imprinted on the opaque cells will be randomly generated or based on algorithms which may vary for each application/user. The characters on the opaque cells can be any printable symbol. The symbol can be character, digits, special symbols etc.

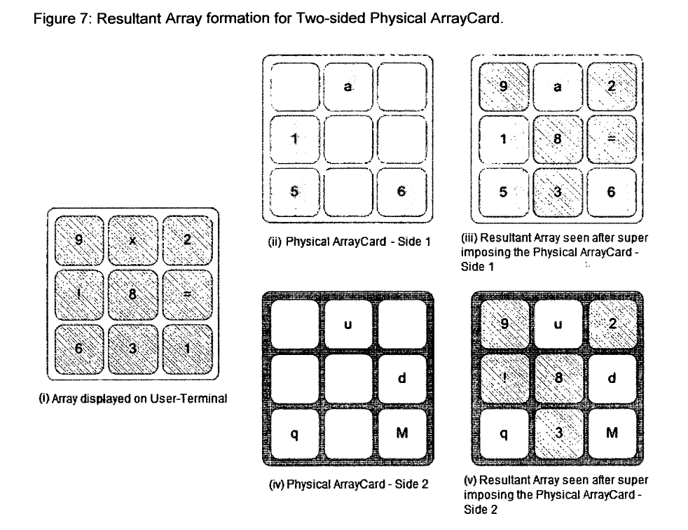

In one of the embodiments, the ArrayCard can be used on both sides with different set of characters printed on two sides of the opaque cells. The two sides can be differentiated by a different color or any other means like numbering the side of the ArrayCard. And the system/user will agree upon which side of the ArrayCard to be used for each transaction. Sample Two-sided ArrayCard is shown in FIG. 7(ii) & FIG. 7(iv).

In one of the other embodiments, multiple ArrayCards can be issued to user and the system will agree upon the ArrayCard that the user has to use for each particular transaction. System/user can also specify more than one ArrayCard to be used in which case the resultant array will be a combination of both the ArrayCards and the array displayed on the User-Terminal.

When an ArrayCard is issued to the user, the system stores the contents of the ArrayCard in the system along with the User-Id to whom the ArrayCard is issued. This can be later used for confirming the authenticity of users.

### 2. Registration: Registration of Pattern by the User

The pattern registration process involves that the system displays an array of symbols on User-Terminal. This Array of cells can be received from the system through real time communication or can be generated at the application side based on some parameters or algorithms without any real time communication with the system. As one of the embodiment if there is no real time communication between the system and the application, the application may send the corresponding parameters for the Array generation to the system or the algorithm for generating the Array is pre-initialized. The algorithms used can subject to vary with the application or user need.

The displayed array will consist of cells with some symbols displayed on each one of the cell. There can be a single or multiple symbols in each cell or it can be left blank. The displayed symbols and/or cells can be differed by using various colors. The symbol(s) can be in the form of a CAPTCHA image so that it cannot be read by automated programs but can be understood by humans. The array can be of any size or shape. Some typical shapes can be square, rectangular etc. The array displayed on the User-Terminal can have a different size or shape than that of the array on the ArrayCard given to the user.

When the ArrayCard is put on top of the array displayed on the User-Terminal such a way that the individual cells are aligned properly (as both of them are of same size and shape), then a new array will be seen by the user as a result of this transformation. The resultant array will contain the characters on the opaque cells in the ArrayCard and for the cells which are transparent the characters in the respective cells on the User-Terminal will be visible. Sample illustration of this overlap can be seen in FIG. 6.

User has to provide his User-Id and personal information, so that the user's pattern registration process can be initiated. In one of the embodiments, user also should have his Unique ArrayCard during the registration process.

### 2.1 Generation of Array to be Displayed on User-Terminal:

Once the system receives the data from the user, it retrieves the ArrayCard structure i.e. the ArrayCard's transparent and opaque positions and the values present in the opaque positions. Based on the user's ArrayCard values, the array of symbols are generated, which is a set of pseudo random symbols that may or may not include the symbols present on the User's ArrayCard. Different kinds of algorithms can be used for generating the array of symbols based on the application/user need.

In one of the other embodiments, the pattern can be registered without the use of ArrayCard, where in the user will be displayed a pseudo random array and he selects the values that are present in the pattern of his choice in the respective sequence. The pseudo random array will be generated based on different kind of algorithms and are specific to the application or user. In this case, the array can be generated either on the User-Terminal or at the system.

Once the characters of the array are generated, they can be converted to CAPTCHA images using CAPTCHA (Completely Automated Public Turing test to tell Computers and Humans Apart) algorithms. This step is optional depending on the application need. All the CAPTCHA images can also be converted into a single bigger CAPTCHA image in the array format. The individual numbers, CAPTCHA images or a single CAPTCHA image can be sent to the User-Terminal based on the application need.

### 2.2 Selection & Registration of User Pattern

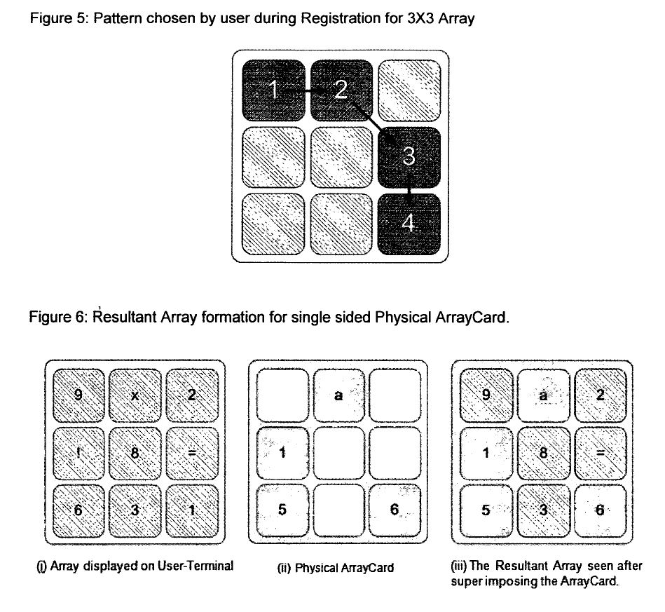

In one embodiment in which the ArrayCard has only one side and of same size that of the array displayed on the User-Terminal, the user has to put his ArrayCard on top of the Array displayed on the User-Terminal. In the resultant array viewed by the user, he picks up his secret pattern (which is set of cells in a particular sequence). FIG. 5 illustrates a sample pattern that the user can choose. It should be noted that the secret pattern may be chosen from the array displayed on the User-Terminal when the sizes of the array on the ArrayCard and the array displayed on the User-Terminal are different. In one of the embodiment if the size of the array displayed on the user terminal and the ArrayCard are different then the user/system may agree upon the alignment of the ArrayCard over the array displayed on the User-Terminal. Once the user picks up the pattern he inputs the values present in that cells as a One-Time-SecretCode. User can input the pattern chosen in various ways, some of them are keyboard, touch pad, over voice etc. For the pattern chosen in FIG. 5, The One-Time-SecretCode for illustration shown in FIG. 6 will be 9a=6. This One-Time-SecretCode is sent to the system.

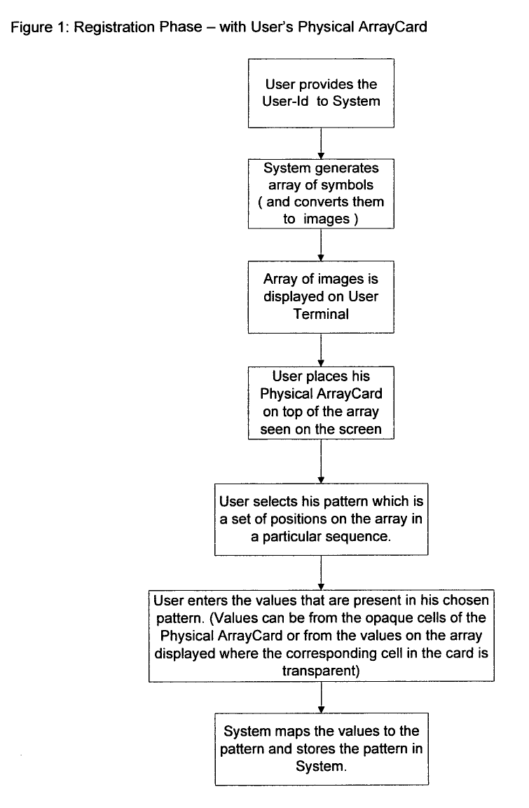

Based on the One-Time-SecretCode received, the set of characters generated for this transaction and the associated User's ArrayCard, the system maps the One-Time-SecretCode to the pattern selected by the user and stores the same in the system. This process is illustrated in FIG. 1.

In another embodiment the user need not put the ArrayCard on top of the Array displayed on the User-Terminal during registration process. He just need to pick up his secret pattern and enters the values present in corresponding cells of the array displayed on the User-Terminal.

And the system maps the pattern based on the One-Time-SecretCode received and the set of symbols generated for that transaction.

### 3. Authentication

Authentication process involves three stages which are:

### 3.1 Challenge Creation

3.2 One-Time-SecretCode entry by user

### 3.3 Response Verification

### 3.1 Challenge Creation

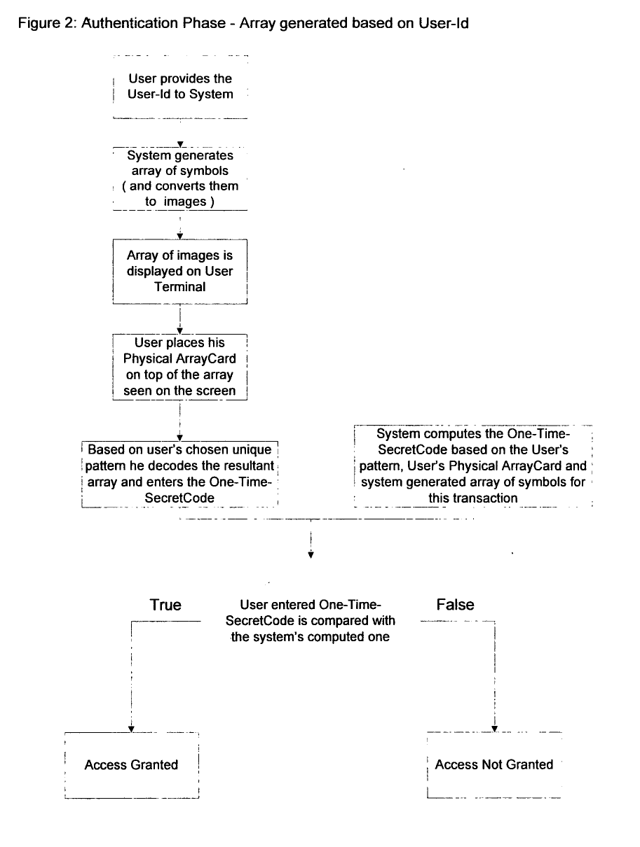

In one of the embodiments user needs to provide his User-Id to initiate the authentication process for granting access to resource to the user (FIG. 2). After receiving the user's id, the system retrieves the ArrayCard structure and the values. The system randomly or based on algorithms takes some of the values present in the ArrayCard and puts them in random or algorithmically chosen cells in the array that needs to be displayed on the User-Terminal. The algorithms can vary with application or user. The other cells in the array are also filled with pseudo random symbols with or without repetition of the already filled symbols (which are present on the opaque cells in the ArrayCard).

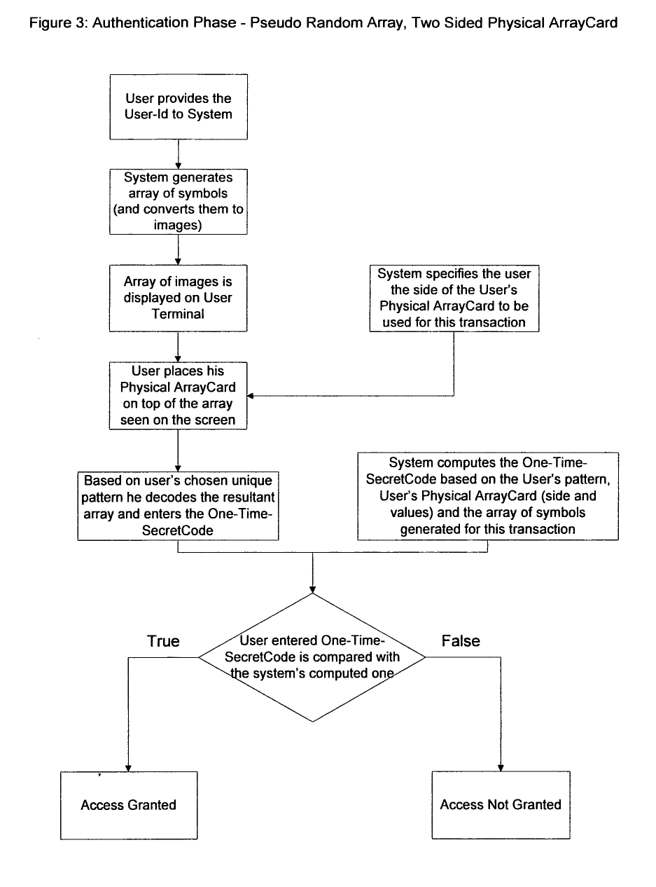

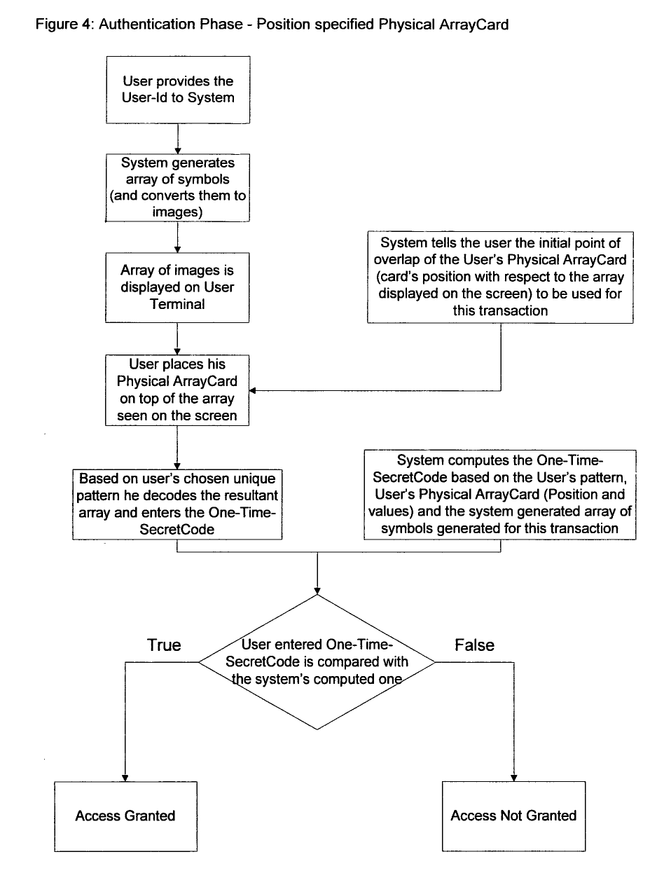

In one of the other embodiments (FIGS. 3, 4), the array can be filled with pseudo random symbols with or without repetition. In this case, the array can be generated either on the User-Terminal or at the Server.

Once the symbols of the array are generated, they will be converted to CAPTCHA images using CAPTCHA algorithms. This step is optional depending on the application/user need. All the CAPTCHA images can also be converted into a single bigger CAPTCHA image in the array format. The individual symbols, CAPTCHA images or a single CAPTCHA image can be sent to the User-Terminal to display to the user based on the application need.

3.2 One-Time-SecretCode Entry by User

In one of the embodiments (FIG. 2), the user places his ArrayCard on top of the Array displayed on the User-Terminal. As both the arrays are of same size and shape in this embodiment, both the arrays exactly overlap. Because of this transformation a new resultant array is visible to the user. User recalls his pattern and enters the values present in those cells of the array as his One-Time-SecretCode for this particular transaction. For the pattern chosen in FIG. 5. The One-Time-SecretCode for illustration shown in FIG. 6 will be 9a=6.

In one of the embodiment, when any of the opaque cells are blank, the user will just ignore entering that particular symbol/enter any other symbol which was agreed between system and user and moves on to enter the remaining symbols as per his pattern.

In one of the other embodiments (FIG. 3), where the ArrayCard has symbols imprinted on both sides, the system and the user agree upon or system may inform the side of the ArrayCard to be used for deriving the One-Time-SecretCode for this transaction. The indication of the side can be done either directly along with display of the array on the User-Terminal or through another mechanism like sending an SMS/Email or by any means to the user. Typical ways of doing it is, sending the indication along with the array on the User-Terminal through a numbering mechanism or through a color coded scheme. One example of a color coded scheme can be that the sides of the ArrayCard have two different colors (say yellow and red). When the displayed array on the User-Terminal is in Yellow color, the user has to use the yellow side of the ArrayCard for deriving the One-Time-SecretCode. For the pattern chosen in FIG. 5, the One-Time-SecretCode for illustration shown in FIG. 7(iii) ArrayCard-Side1 will be 9a=6 and the One-Time-SecretCode for illustration shown in FIG. 7(v) ArrayCard-Side2 will be 9udM.

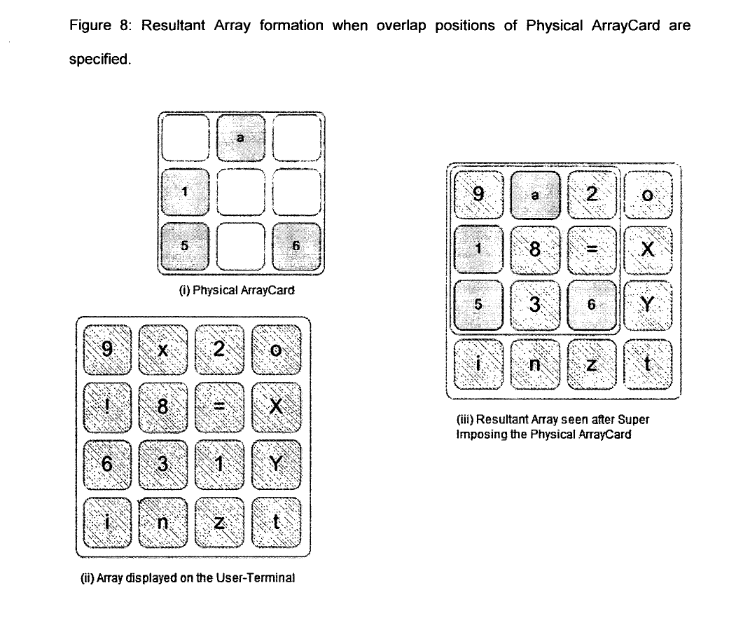

In one of the other embodiments (FIG. 4), the system will also inform the user the position of the ArrayCard where it needs to be put on top of the array displayed on the User-Terminal. This can be achieved in various ways like displaying the row and column positions on the User-Terminal or sending the information through a SMS/Email, using a coloring scheme etc. One such way is as follows: The user's ArrayCard is colored in Red color and array is of square shape and of size 3×3 (i.e. 3 rows, 3 columns). The array displayed on the User-Terminal is of square shape and size 6×6. The coloring of the array displayed on the User-Terminal is such a way that a particular sub-array of 3×3 size will be in Red color and other cells in any other color (say Blue). That basically means that the user has to place his ArrayCard on the red color cells and enter his pattern from the resultant array displayed on the User-Terminal after placing the ArrayCard. It should also be noted that in an additional embodiment, there will be a case where in there will be smaller sub cells of 2×2 size colored in Red which are at the outer surface of the array. In that case, the user has to put only the partial card on top of these four cells alone and not on any of the other cells in the array which are not colored in Red. This arrangement will result in a different resultant array. User recalls his pattern in this resultant array and enters the values present in those cells of the array as his One-Time-SecretCode for this particular transaction. If any of the cells chosen from the secret pattern is empty (no symbol or that particular cell is not overlapped on the displayed array) then user may skip or he can enter any of the symbol that system and user agree upon and continue with the rest of the pattern. For illustration shown in FIG. 8 if user selects his pattern as four corner elements in clock-wise direction starting from top left, then the One-Time-SecretCode for illustration shown in FIG. 8 will be 9oti.

In one of the embodiments, the user will not use the ArrayCard and will directly enter the values present in his chosen pattern of cells on the array displayed on the User-Terminal.

3.3 Response Verification

After receiving the One-Time-SecretCode from the User-Terminal, the system will independently compute the One-Time-SecretCode for this transaction based on the transformation which uses User's ArrayCard, displayed array on User-Terminal and User's stored pattern. In one of the embodiments it will also consider the side of the ArrayCard that user is specified to use, the position at which user has been asked to put the ArrayCard as applicable.

Now the system compares the value entered by the user to the value computed by the system after applying the transformation. And if they match, access will be granted for the user. If there is no match then access will be denied.

Alternatively, the received One-Time-SecretCode from the User-Terminal is converted back to the pattern based on the User's ArrayCard, displayed array of characters on User-Terminal for the particular transaction. And this converted pattern is matched with the user's stored pattern to grant access to the user.

### 2) Use of Virtual ArrayCard

In the other embodiment, every user is given the application on his respective device. The applications can be run in Mobile or a Stand Alone application in PC or can be run in the browser as a browser plug-in. And each user is given a seed which needs to be placed in the application. This seed can be in various forms like a string of symbols or an image or an encrypted file etc. It is from this seed that the dynamic Virtual ArrayCards are generated which are bound to a particular application or the user. In one of the embodiments other factors/parameters are also taken into account along with the seed to generate the Virtual ArrayCard. In one of the embodiment each user can have more than one application installed in his device. At the time of login the user sees an Array of cells on which the transformation has been applied with the use of Virtual ArrayCard. From the resultant array, the user will derive the One-Time-Secret code based on chosen pattern.

The application in which the Array of Cells is displayed can be same or different from the application/system for which the access needs to be provided. When both the applications/systems are different, they can be in same or different devices.

Following are the various steps which illustrate the operation of the invention with the usage of the Virtual ArrayCard

### 1. Registration: Issuing of Virtual ArrayCard Seed

Each user is issued a unique Virtual ArrayCard Seed. Using this seed a dynamic Virtual ArrayCard structure is generated. The Virtual ArrayCard consists of an array of cells with some cells being transparent and others being opaque. Sample Virtual ArrayCard is shown in FIG. 13

The number and positions of opaque cells and transparent cells can change dynamically based on application/user. The positions where the transparent and opaque cells need to be placed are determined randomly (where the randomization is initiated by the Virtual ArrayCard's Seed) or based on any specific requirement of the application or based on any of the distinct parameters for that particular transaction. The characters imprinted on the opaque cells can change dynamically which may vary for each application/user. When a Virtual ArrayCard Seed is issued to the user, the system stores the Seed, along with the User-Id to whom the Virtual ArrayCard Seed is issued.

### 2. Registration: Registration of Pattern by the User

An array of symbols will be displayed on the User-Terminal and it may or may not be a resultant array. Resultant array is the array obtained after the transformation applied on the Array of cells using the Virtual ArrayCard. This Array of cells can be received from the system through real time communication or can be generated at the application side based on some parameters or algorithms without any real time communication with the system. As one of the embodiment if there is no real time communication between the system and the application, the application may send the corresponding parameters for the Array generation to the system or the algorithm for generating the Array is pre-initialized. The algorithms used can subject to vary with the application or user need.

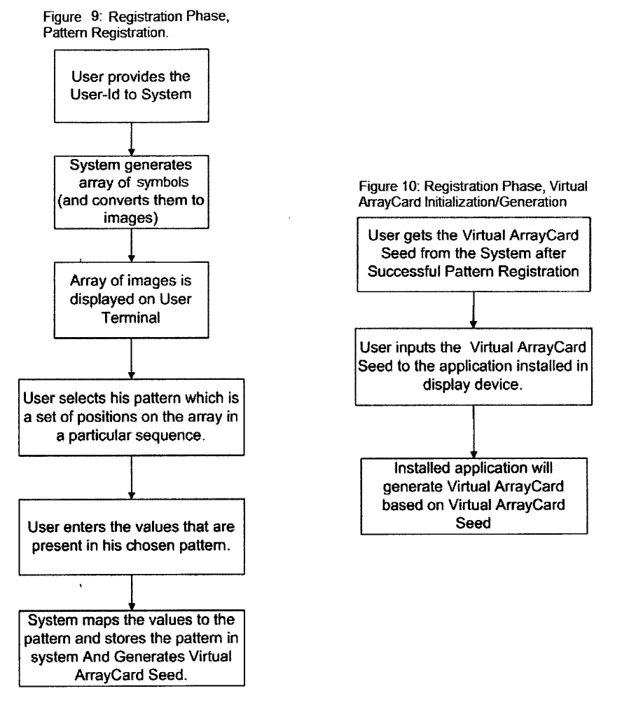

User has to provide the personal information, so that the user's pattern registration process can be initiated. This process is explained in FIGS. 9 & 10

### 2.1 Generation of Array to be Displayed on User-Terminal:

Once the application receives the Virtual ArrayCard Seed, based on the seed along with other factors it retrieves the Virtual ArrayCard structure i.e. the Virtual ArrayCard's transparent and opaque positions and the values present in the opaque positions. The Virtual ArrayCards are generated in the same or different way for every transaction based on the distinct parameters for that particular transaction. Different kinds of algorithms can be used for generating the array of symbols based on the application/users need. The Virtual ArrayCard which is generated is overlapped on the array of cells and a resultant array after the transformation is shown to the end user on the display terminal.

### 2.2 Selection & Registration of User Pattern

From the resultant array user will choose a sequence of cells as the secret pattern. The registration process is illustrated in FIGS. 13 & 14.

Based on the One-Time-SecretCode received from the user, the system maps the One-Time-SecretCode to the pattern selected by the user and stores securely in the system.

### 3. Authentication

Authentication process involves three stages which are:

### 3.1 Challenge Creation

3.2 One-Time-SecretCode entry by user

### 3.3 Response Verification

### 3.1 Challenge Creation

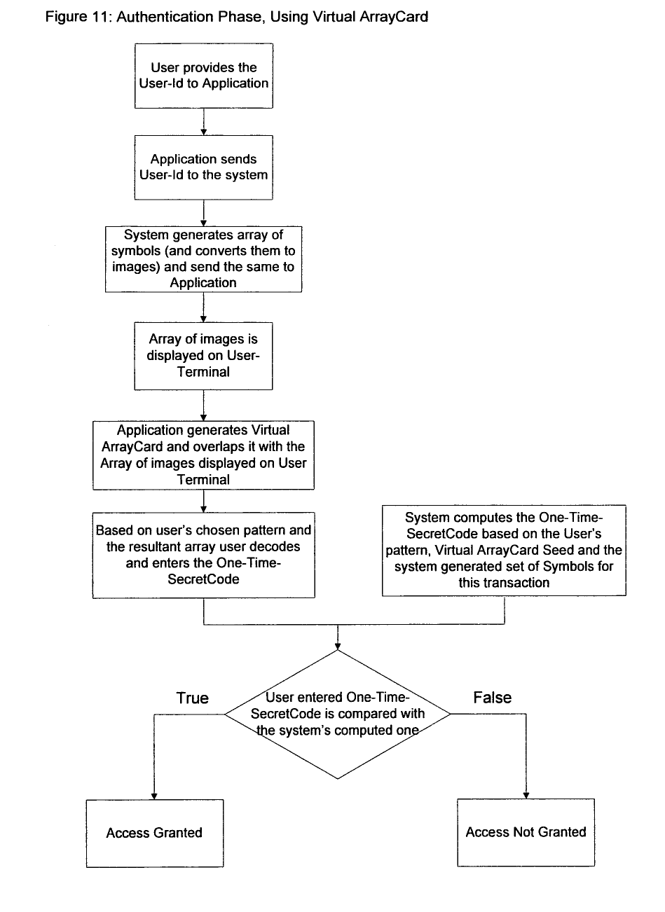

In one of the embodiments user needs to provide user specific data to initiate the authentication process for granting access to the resource as illustrated in the FIG. 11. The Virtual ArrayCard which is generated is overlapped on the array of cells and a resultant array after the transformation is shown to the end user on the display terminal. This overlap may or may not be shown to the user visually. In the case when the overlap is not shown visually the resultant array will be directly shown to the user.

### 3.2 One-Time-SecretCode Entry by User

In one of the embodiments (FIGS. 11 and 13), both the arrays (Virtual ArrayCard and the Array of cells) exactly overlap creating a new resultant array after applying the transformation, is visible to the user. User recalls his pattern and enters the values present in those cells of the array as his One-Time-SecretCode for this particular transaction.

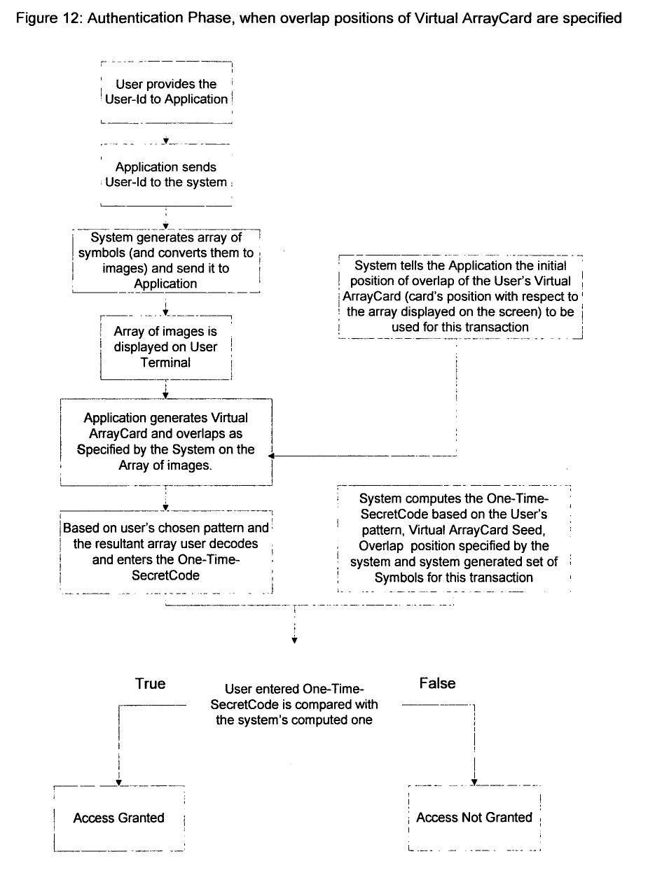

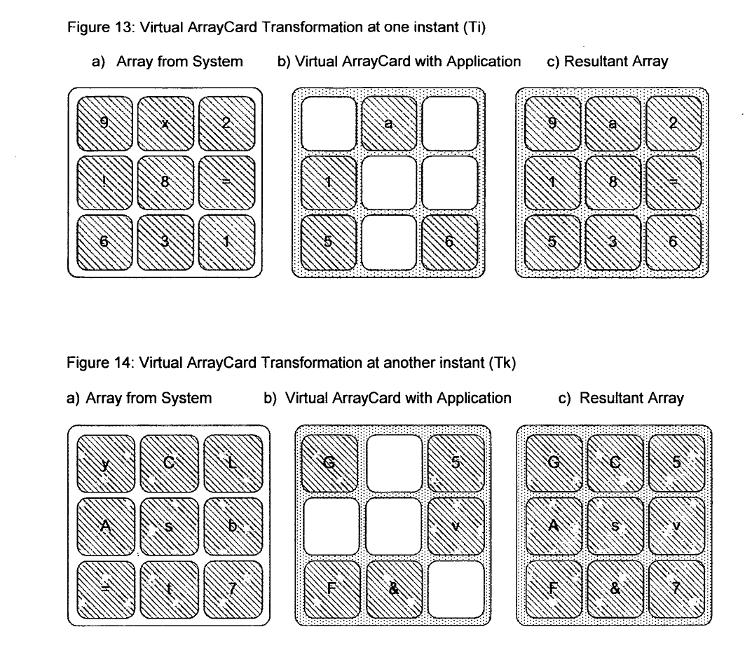

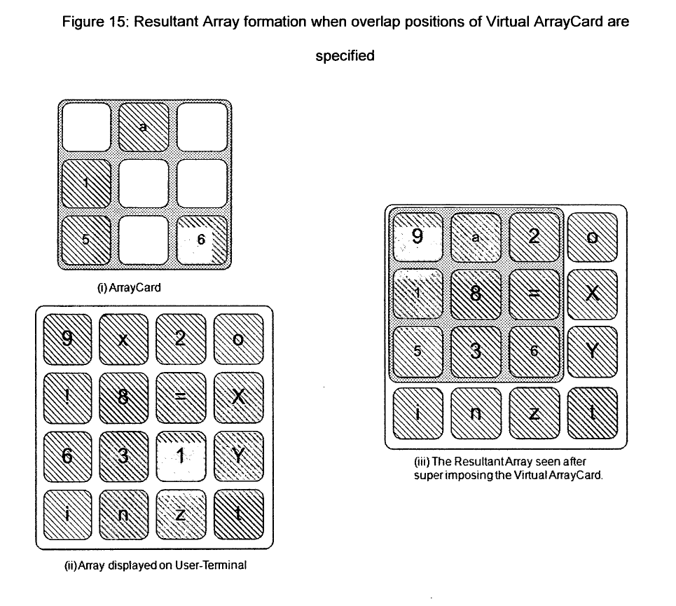

In one of the embodiment, the system can specify the alignment of the Virtual ArrayCard with the Array of cells, FIGS. 12, 15.

In one of the embodiment, when any of the opaque cells are blank, the user will just ignore entering that particular element and moves on to enter the remaining values as per his pattern.

### 3.3 Response Verification

After receiving the One-Time-SecretCode from the User-Terminal, the system will identify the Virtual ArrayCard and the array of cells being used by the user and the transformation mechanism, and generates a resultant array with which it matches the resultant array of the user which the user used for login. And computes the pattern from the One-Time-SecretCode and the resultant array, if this pattern matches with the registered pattern of the user then the user will be authenticated.

### 3) Use of Electronic ArrayCard

In the other embodiment every user is given an Electronic ArrayCard where in it consists of opaque and transparent cells like Physical ArrayCard, unlike in the Physical ArrayCard where the structure of the Array (number of cells, positions, size, color, shape, number of opaque and transparent cells) is static, But in the case of Electronic ArrayCard the structure of the Array (number of cells, positions, size, color, shape, number of opaque and transparent cells) is dynamically changing with respect to some parameter or an algorithm. Some of the parameters can be time or event count etc. The Electronic ArrayCard can be of any type, shape, material. The displayed Array on the Electronic ArrayCard will have a combination of transparent as well as opaque cells where the symbols in the opaque cells or number of cells, position of opaque and transparent cells, size, color of both cells and symbols or other kind of parameters will be dynamically generated. This Electronic ArrayCard can be used to overlap on any displayed Array of cells in an application as a transformation which produces resultant array. Based on the secret pattern chosen by the user, user can derive One-Time-SecretCode from the resultant array. This One-Time-SecretCode is communicated to the system for authentication.

The application in which the Array of Cells is displayed can be same or different from the application/system for which the access needs to be provided. When both the applications/systems are different, they can be in same or different devices.

### Other Forms of Transformation

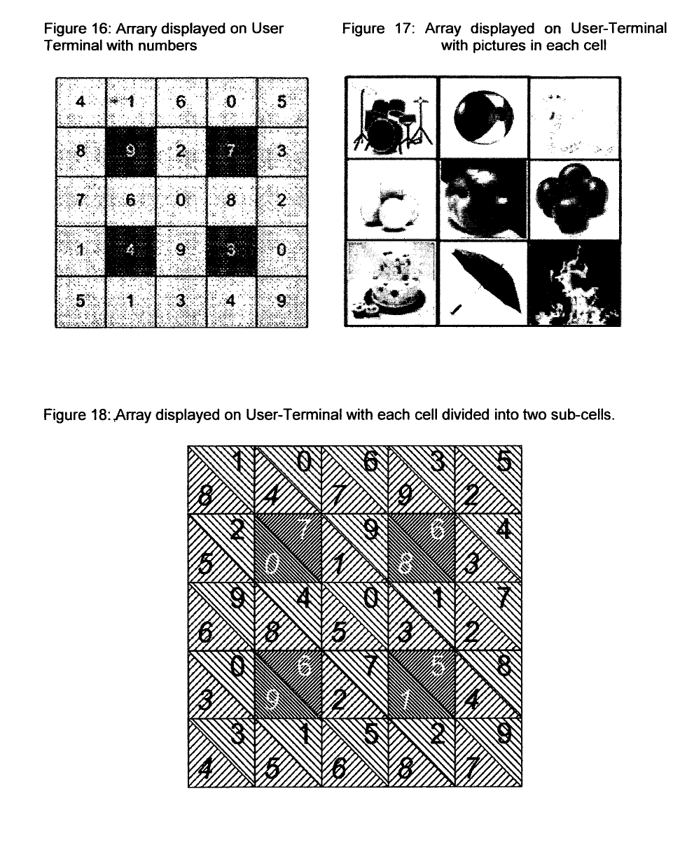

Using ArrayCard is one form of transformation to derive the One-Time-SecretCode. Some of the other variants of transformations are:
i. Use of Mathematical Operations.
ii. Displaying Multiple Sub-Cells in each Cell of the Array.
iii. Displaying Pictures of Person/Object in each cell of the Array.

[i] Use of Mathematical Operation: In one of the embodiment the transformation of the Array of cells can be done through mathematical operations. In this, at the time of Registration, along with choosing the pattern the user has to choose two things, (1) what type of operations he wants to use and (2) the value of the operand which are used for the transformation. The operation can be any mathematical function like a simple modulo addition or modulo subtraction etc. For example, at the time of the registration user selects operation as modulo addition and the operand as one. And if the user selects four corners (starting from top-left in the clock-wise) as the secret pattern, the numbers in his secret pattern from the FIG. 16 will be 4595. But as the user selected operation and operand as modulo addition and one respectively, then the resultant One-Time-SecretCode will be

4+1=5

5+1=6

9+1=0

5+1=6

Hence the user has to enter 5606 as the One-Time-SecretCode. For the same example, if the user chooses normal addition instead of modular addition then the resultant One-Time-SecretCode will be

4+1=5

5+1=6

9+1=10

5+1=6

Hence the user has to enter 56106 as the One-Time-SecretCode. If the user selects Subtraction as the operation and 2 as operand, the resultant One-Time-SecretCode will be

4−2=2

5−2=3

9−=7

5−2=3

Hence the user has to enter 2373 as the One-Time-SecretCode. Similarly the user can choose more complex operations like Modulo Multiplication, Modulo Division, Normal Subtraction, Normal Multiplication, Normal Division and exponentiation operation etc. The symbols displayed on the Array of cells can be any printable symbol mostly numbers are displayed. The operations can be any type typically concatenation, addition, substitution etc.

[ii] Displaying Multiple Sub-Cells in each cell of the Array: In the other embodiment, each cell of the array will be divided into two or more Sub-cells and each Sub-cell contains one symbol (FIG. 18 illustrates a case where each cell is divided into two Sub-cells). At the time of the registration along with selecting the pattern, the user has to select the Sub-cells.

The user can choose either all the upper Sub-cells or lower Sub-cells of the array or any zigzag fashion etc. When the Array is displayed the transformation is applied by using the Sub-cell position which has been already chosen. For example if the user selects four corners in the clockwise direction as the secret (FIG. 18). Along with the pattern, if the user selects Upper cells as the secret, the user's One-Time-SecretCode will be 1593. If the user selects Lower cells as the secret, the user's One-Time-SecretCode will be 8274. In the other embodiment, the user can choose alternative Sub-cells as the secret, i.e., the user can choose the upper Sub-cell for first position, lower Sub-cell for second position and similarly for the rest of the positions.

[iii] Displaying Pictures of Person/Object in each cell of the Array: In the other embodiment picture of a person/object can be displayed in each cell of the Array (FIG. 17). For every login the positions of the images may change or the images themselves may change.

Whenever user wants to login, the system will display the picture array and will ask some questions. A sample question can be, “Enter the first two characters of the items in the image that are there in your pattern”. That means the transformation is converting the images to symbols. For illustration, let us consider the user selected the secret as the four corners (starting from top left, in the clock wise direction). The items that are there in the four corners are drums, snake, fire, cake. For the above query, the One-Time-SecretCode of the user will be “drsnfica”. Similarly the server can ask, “Enter the last three characters of the items in the image that are there in your pattern cells”. The corresponding One-Time-SecretCode for the user will be “umsakeireake”. This One-Time-SecretCode can be communicated to the system for authentication.

### ADVANTAGES OF THE INVENTION

Being a two factor authentication system, where in one factor of authentication is the pattern remembered by the user and the second factor being the transformation applied by the user. The transformation can be in the form of Physical/Virtual/Electronic ArrayCard or any additional secret. Multiple factors of authentication provide additional level of security against hacking attempts.

In this section we outline how our invention provides better security from various possible security attacks.

In Bruteforce attack, hacker will give a random string as the password to system and if system responds to that request as invalid password, the hacker is sure that given string is not the user's password. Then hacker will try with some other password and gradually the hacker will reduce the search space of the password and after a finite number of attempts the hacker can deduce the password of the user. Where as in the present invention, the One-Time-SecretCode will change for every login request. Hence even after infinite attempts the hacker cannot predict the user's next One-Time-SecretCode with 100% accuracy. Hence the current invention will give strong protection against Bruteforce.

Dictionary attack can be applied to the present system based on the position i.e. the hacker will build a dictionary of commonly used patterns and will feed this dictionary as the Input to the Internet bots. But the difficulty that is associated with this method is twofold, one the hacker will not be aware of the user's ArrayCard values or the transformation mechanism used by the user, so though he might try the commonly used patterns but cannot succeed because he is not aware of the values in the opaque cells of the ArrayCard. The second difficulty is that to apply the dictionary based attack the hacker has to use an Optical Character Recognition (OCR) to identify the characters in the Array which is computationally long and doesn't guarantee full success rate. Due to above two difficulties it can be deduced that the probability of success of Dictionary based attack is minimal for the current invention.

Shoulder surfing can be done easily on the Password-Based authentication system just by seeing the keys that the user is typing. But to decode the Pattern in the present system, the hacker has to see both the key sequence the user is typing and the resultant array after overlapping the ArrayCard. And also has to do a mapping before the user submits the page. This can be explained with the following example; let us consider a situation where a hacker is observing someone from his back and noting all the keys that are typed by the user. In the case of the Password-Based system, if the hacker observes that the user types the key ‘R’ on his keyboard, then the hacker is sure that the user's Password has ‘R’ and even the hacker can identify the complete Password of the user. But in the case of the current system even if the hacker observers that the user typed the character ‘R’, the hacker have to identify the position of the ‘R’ in the resultant array. As the user knows his secret position, it is easy for the user to identify the character as ‘R’. But for the hacker, he/she has to linearly search each and every cell of the Array to identify the position of the ‘R’ in the Array. By the time the hacker identify the position of ‘R’, the user will type all other characters of his One-Time-SecretCode. So Shoulder Surfing will not be effective for the current invention.

Guessing is the simplest attack that a hacker can do on a User Authentication system. For typical pattern based systems, the hacker can do the guessing by trying out frequently used patterns like all diagonal corners of the array, patterns based on the knight moves etc. This will become very difficult in our present invention because of the non-availability of the User's transformation mechanism to the hacker. That means the hacker does not know the ArrayCard or the Virtual ArrayCard or the formula used for the transformation for that particular transaction. That becomes very difficult to the hacker to guess.

Another kind of attack is through the Keyloggers which are hardware or software based. The Keyloggers will periodically send all the captured keystrokes to the person who wrote the program. Once all the captured keystrokes are received, the hacker will process the data and can extract the credentials (username/password) of the user. The natural protection for an authentication system from the Keyloggers is to have a onetime password (or Dynamic password). The current invention being a dynamic password system is not vulnerable to Keyloggers. Even if the hacker gets the One-Time-SecretCode of the user, this One-Time-SecretCode cannot be reused by the hacker to login to the system (because of the dynamic nature of the Array of cells) and there is no way that that the hacker can get the Pattern of the user from the One-Time-SecretCode of the user. Hence the current invention can give complete protection from both the Software Keyloggers and the Hardware Keyloggers.

Advanced hacking technique for gaining sensitive information by a hacker is to install Keyloggers and Screenloggers on the target machines on the Internet. With the help of the Screenloggers the hacker can get the periodic screenshots of what is displayed to the user on the User-Terminal. With the gained knowledge of the keys pressed and the array displayed the hacker will be able to deduce the user's pattern in the case of other pattern based systems that are previously proposed (the ones that are outlined in the Prior art section).

But this kind of attack by the hacker will not be able to compromise the user's pattern in the system that we have presented in this invention. Even if the hacker comes to know the array displayed on the User-Terminal and the keys user pressed he cannot deduce the pattern because of the following reasons:
The hacker has no way of finding the kind of transformation applied on the displayed array by the user.
For example if the transformation used is through ArrayCard then the symbols present in the user's ArrayCard are repeated at a different position on the array displayed on the User-Terminal. So there is no way that the hacker will come to know if any key that is entered is based on the position of the symbol in the array displayed on User-Terminal or the User's ArrayCard.
If the transformation is through Virtual ArrayCard then the hacker has no way of knowing the ArrayCard used for that particular transaction.

Even when the user loses the ArrayCard and it lands in some unsafe hands, it will not compromise the user's safety as user's pattern also needs to be known to gain access to the system.

Phishing has become easiest and most powerful way of stealing Username/Password from users. The popular way of phishing is, the hacker sends a mail to users saying their account is blocked because of too many login failures and ask them to login, in order to prevent the account to be locked permanently. When the user clicks on the bank URL link in the mail, the user is redirected to a site which is developed by the hacker and looks exactly like the genuine Bank site. When the user enters the Username/Password, the site will say login failure and redirects to the actual bank site. But the hacker will gain the confidential information of the user and can mimic the user and there is no way the user will know about this. But in the present invention the user will enter the One-Time-SecretCode based on the transformation applied on the Array that is rendered on the User's Terminal. Even if the hacker captures the user's One-Time-SecretCode, the hacker can't predict the user's pattern because the hacker doesn't have any information about the user's ArrayCard or other modes of Transformations the user used.

Replay attack is a network attack in which a valid data transmission is captured by the hacker and replayed at a later point of time. Due to the dynamic nature of the One-Time-SecretCode in the current invention the, a valid One-Time-SecretCode will not be valid for transaction happened at a later point of time.

MITM (Man in the Middle) and MITB (Man in the Browser) are other form of attacks which uses the vulnerabilities of the browser or communication channel between user and system. In one of the embodiments of the invention where parameters known to user and the system are used in the generation of the Virtual ArrayCard, even if the hacker successfully deploys the above attack by changing the data it will result in the failure at the time of validating the credentials hence protection against these attacks.

Using the Virtual/Electronic ArrayCard for the transformation is like using multiple ArrayCards as if unique ArrayCard is placed on the Array rendered for each transaction. So this kind of transformation is much more robust for all hacking attacks. Because the transformation applied by the user is unique for each transaction. Theoretically it is not possible for the hacker to find out the exact transformation applied as he has no access to the Virtual/Electronic ArrayCard.

1. A user authentication system provides a secure transaction that occurs to access a resource, using a One-Time-Secret-Code for each transaction; wherein the One-Time-Secret-Code will be derived by the user using a transformation on the Array of cells which is displayed on the user terminal using the secret remembered by the user. The said system comprising:
(a) an array of cells displayed on a display terminal which has characters or symbols present in each cell.
(b) a secret on which user and the system agree upon at the time of registration. The secret would be a pattern which is a sequence of positions or cells in the Array.
(c) a Physical or Virtual (tangible or intangible) thing or a secret which is used for transformation of the displayed Array of cells.

2. The system according to claim 1, can be used for the authentication of the user to the application or the authentication of any application with any other application.

3. The system according to claim 1, wherein the said One-Time-SecretCode can be derived applying transformation in any form; Some of the typical forms are Physical ArrayCard, Virtual ArrayCard, Electronic ArrayCard or a secret remembered by the user.

4. A new user authentication system utilizing a unique Physical ArrayCard comprising:
(a) issuing of ArrayCard to each user and storing the contents of the ArrayCard in the system; wherein said ArrayCard has transparent and opaque cells, said opaque cells have characters imprinted on it and some left blank;
(b) pattern registration process in which the system displays an array of characters on user-terminal; the said ArrayCard of the user is put on top of the array displayed on the user-terminal resulting in a new array viewed by the user; user can select sequence of cells as the registration pattern
(c) authentication process in which the system displays an array of characters on user-terminal; the said ArrayCard of the user is put on top of the array displayed on the user-terminal resulting in a new array viewed by the user; user enters the values seen in his selected pattern as One-Time-Secret-Code
(d) where after receiving the One-Time-SecretCode from the User-Terminal the system will independently compute the One-Time-SecretCode for this transaction based on the transformation which uses User's ArrayCard, displayed array on User-Terminal and User's stored pattern.
(e) wherein said system compares the value entered by the user to the value computed by the system after applying the transformation; if they match access is granted for the user and access is denied to the user when there is no match

5. The ArrayCard according to claim 4, wherein opaque cells have multiple characters imprinted on each opaque cells

6. The ArrayCard used for transaction according to claim 4, can be single sided or two sided

7. The authentication system of claim 4, issues multiple ArrayCard for a single user and the system will agree upon the ArrayCard that the user has to use for each particular transaction

8. The authentication system of claim 4 wherein overlaying the ArrayCard on the Array of cells displayed on the display terminal is based on a particular position on the displayed array chose by the system and user.

9. The authentication system of claim 4, wherein the new array can be generated either on the user terminal or at the server

10. The authentication system of claim 4, wherein generated characters of array can be converted to CAPTCHA images.

11. A new user authentication system utilizes a unique Virtual ArrayCard comprising:
(a) Virtual ArrayCard Seed is issued to the user, the system stores the contents of the seedalong with the User-Id to whom the Virtual ArrayCard Seed is issued
(b) during registration process, the application receives the Virtual ArrayCard Seed from the user and it retrieves the Virtual ArrayCard structure; after the transformation by overlapping the Virtual ArrayCard and the array of cells from the system, a resultant array displayed on the user terminal wherein the user can choose the secret pattern; the system maps the One-Time-SecretCode to the pattern selected by the user and stores the same
(c) during transaction process, both the arrays (Virtual ArrayCard and the Array of cells) overlap creating a new resultant array after applying the transformation is visible to the user. User recalls his pattern and enters the values present in those cells of the array as his One-Time-SecretCode for this particular transaction
(d) where after receiving the One-Time-SecretCode from the User-Terminal the system will independently compute the One-Time-SecretCode for this transaction based on the transformation which uses User's Virtual ArrayCard Seed, displayed array on User-Terminal and User's stored pattern.
(e) wherein said system compares the value entered by the user to the value computed by the system after applying the transformation; if they match access is granted for the user and access is denied to the user when there is no match

12. The Virtual ArrayCard as said in claim 11, wherein the number and positions of opaque cells and transparent cells as well as characters on the opaque cells can change dynamically for each transaction

13. The authentication system of claim 11, wherein the values generated on the Virtual ArrayCard per each transaction is dependent on a parameter entered by the user for each transaction along with the Virtual ArrayCard Seed.

14. The application for the Virtual ArrayCard of claim 11, can be run in Mobile or a Stand Alone application in PC or can be run in the browser as a browser plug-in

15. An user authentication system employs an unique Electronic ArrayCard comprising:
(a) every user is given an Electronic ArrayCard wherein the structure of opaque and transparent cells and the characters on the opaque cells change dynamically with respect to an algorithm or parameter
(b) pattern registration process in which the system displays an array of characters on user-terminal; the said Electronic ArrayCard of the user is put on top of the array displayed on the user-terminal resulting in a new array viewed by the user; user can select sequence of cells as the registration pattern
(c) authentication process in which the system displays an array of characters on user-terminal; the said Electronic ArrayCard of the user is put on top of the array displayed on the user-terminal resulting in a new array viewed by the user; user enters the values seen in his selected pattern as One-Time-Secret-Code
(d) where after receiving the One-Time-SecretCode from the User-Terminal the system will independently compute the One-Time-SecretCode for this transaction based on the transformation which uses User's Electronic ArrayCard, displayed array on User-Terminal and User's stored pattern.
(e) wherein said system compares the value entered by the user to the value computed by the system after applying the transformation; if they match access is granted for the user and access is denied to the user when there is no match

16. The authentication system according to claims 1 & 2, wherein the other variants of transformation include the use of mathematical operations

17. The authentication system of claims 1 & 2, wherein the transformation employs multiple sub-cells in each cell of the array

18. The authentication system of claims 1 & 2, wherein it can be displayed with pictures of person or object in each cell of the Array

19. The system of claims 1 & 2, wherein the application in which the Array of Cells is displayed can be same or different from the application/system for which the authentication needs to be provided.

20. The system of claim 19, wherein when both the applications/systems are different, they can be in same or different devices.

21. The authentication system as said in claims 4, 11 and 15, wherein the received One-Time-SecretCode from the User-Terminal is converted back to the pattern based on the User's ArrayCard, displayed array of characters on User-Terminal for the particular transaction and this converted pattern is matched with the user's stored pattern to grant access to the user.
